(19) United States
(12) Patent Application Publication
(10) Pub. No.: US 2023/0356303 A1
(43) Pub. Date: Nov. 9, 2023

(54) TOOL AND CUTTING INSERT FOR INTERNAL COOLING, AND METHOD OF MANUFACTURING THEREOF

(71) Applicant: NO CREW LTD., Hevel Modi'in (IL)

(72) Inventor: Gershon Harif, Ramat Gan (IL)

(21) Appl. No.: 18/223,715

(22) Filed: Jul. 19, 2023

Related U.S. Application Data
(63) Continuation of application No. 17/057,908, filed on Nov. 23, 2020.
(60) Provisional application No. 62/675,790, filed on May 24, 2018.

(51) Int. Cl. B23B 27/10; B23B 27/14; B23B 27/22; B23B 29/04; B24B 19/02; B24B 27/033

(52) U.S. Cl. CPC B23B 27/10; B23B 27/143; B23B 27/145; B23B 27/22; B23B 29/043; B24B 19/02; B24B 27/033; B23B 2200/0452; B23B 2200/087; B23B 2200/286; B23B 2205/12; B23B 2250/12

(57) ABSTRACT

A cutting insert is provided, comprising a top surface, a bottom surface, and side surfaces spanning therebetween, the side surfaces comprising one or more feed-facing side surfaces and one or more radial-facing side surfaces. The top surface is formed with one or more linear grooves, each constituting a chip breaker and being disposed parallel to and adjacent one of the feed-facing side surfaces. The chip breaker is characterized by a constant profile along the entire length of its respective feed-facing surface. Each of the feed-facing side surfaces is disposed at an acute feed-angle with respect to the top surface, and each of the radial-facing side surfaces being disposed at an acute radial-angle with respect to the top surface, the feed-angle being greater than the radial-angle.

### TECHNOLOGICAL FIELD

The presently disclosed subject matter relates to cutting tools, in particular to those comprising a cutting tool holder and a replaceable cutting insert.

### BACKGROUND

Cutting tools are commonly used in machining operations. Such cutting tools typically comprise a cutting tool holder, and a replaceable cutting insert mounted thereon. The cutting insert performs the actual machining, and thus is subject to wear resulting therefrom. This wear arises from, e.g., heat, mechanical stress, etc.

In typical use, once a cutting insert has been subject to sufficient wear that it is no longer effective to perform its required function, the machining operation is halted, and the cutting insert is replaced.

### SUMMARY

According to one aspect of the presently disclosed subject matter, there is provided a cutting tool comprising a cutting insert mounted in a cutting tool holder, the cutting insert comprising a top surface, a bottom surface, and side surfaces spanning therebetween, the side surfaces comprising one or more feed-facing side surfaces and one or more radial-facing side surfaces, the top surface being formed with one or more linear grooves, each constituting a chip breaker and being disposed parallel to and adjacent one of the feed-facing side surfaces, the chip breaker being characterized by a constant profile along the entire length of its respective feed-facing surface, each of the feed-facing side surfaces being disposed at an acute feed-angle with respect to the top surface, and each of the radial-facing side surfaces being disposed at an acute radial-angle with respect to the top surface, the feed-angle being greater than the radial-angle;

the cutting tool holder being configured to advance in a radial direction during a cutting operation, the cutting tool holder comprising a base, a radial-facing sidewall extending upwardly therefrom and being disposed transverse to the radial direction, and a feed-facing sidewall extending upwardly from the base and being disposed transverse to the radial-facing sidewall, an insert seat space being defined above the base and between the sidewalls, the base being tilted upwardly in a direction away from the radial-facing sidewall about an first axis being transverse to the radial direction, and perpendicular to the feed-facing sidewall;

wherein the cutting insert is received within the insert seat space with its bottom surface facing the base.

The cutting insert may be mounted in the insert seat space of the cutting tool holder such that the one or more radial-facing side surfaces are disposed parallel to the radial-facing sidewall of the cutting tool holder.

The cutting insert may comprise oppositely disposed feed-facing side surfaces and oppositely disposed radial-facing side surfaces.

The cutting insert may further comprise a cavity formed therein, the cavity having an opening formed in the bottom surface and converging upwardly toward a top end thereof (i.e., of the cavity) disposed adjacent to the cutting edge, the side surface and the top end of the cavity defining a thin-walled structure therebetween.

The cutting insert may further comprise one or more ribs projecting into the cavity from its top end.

The base of the cutting tool holder may further be tilted upwardly in a direction away from the feed-facing sidewall about a second axis being perpendicular to the first axis and parallel to the radial direction, wherein the tilting about the first axis is to a greater degree than the tilting about the second axis.

The cutting tool holder may be configured to advance toward a workpiece rotating about a workpiece axis, a cutting plane being defined passing through the workpiece axis parallel to the radial direction, the first axis being parallel to the cutting plane.

The cutting tool may be configured to perform a turning operation.

According to another aspect of the presently disclosed subject matter, there is provided a cutting insert comprising a top surface, a bottom surface, and side surfaces spanning therebetween, the side surfaces comprising one or more feed-facing side surfaces and one or more radial-facing side surfaces,

the top surface being formed with one or more linear grooves, each constituting a chip breaker and being disposed parallel to and adjacent one of the feed-facing side surfaces, the chip breaker being characterized by a constant profile along the entire length of its respective feed-facing surface,

each of the feed-facing side surfaces being disposed at an acute feed-angle with respect to the top surface, and each of the radial-facing side surfaces being disposed at an acute radial-angle with respect to the top surface, the feed-angle being greater than the radial-angle.

The cutting insert may comprise oppositely disposed feed-facing side surfaces and oppositely disposed radial-facing side surfaces.

The cutting insert may further comprise a cavity formed therein, the cavity having an opening formed in the bottom surface and converging upwardly toward a top end thereof (i.e., of the cavity) disposed adjacent to the cutting edge, the side surface and the top end of the cavity defining a thin-walled structure therebetween.

The cutting insert may further comprise one or more ribs projecting into the cavity from its top end.

According to a further aspect of the presently disclosed subject matter, there is provided a cutting tool holder configured to hold a cutting insert to form a cutting tool, and to advance in a radial direction during a cutting operation, the cutting tool holder comprising a base, a radial-facing sidewall extending upwardly therefrom and being disposed transverse to the radial direction, and a feed-facing sidewall extending upwardly from the base and being disposed transverse to the radial-facing sidewall, an insert seat space being defined above the base and between the sidewalls for receiving the cutting insert therewithin,

the base being tilted upwardly in a direction away from the radial-facing sidewall about a first axis being transverse to the radial direction, and perpendicular to the feed-facing sidewall.

The base may further be tilted upwardly in a direction away from the feed-facing sidewall about a second axis being perpendicular to the first axis and parallel to the radial direction, wherein the tilting about the first axis is to a greater degree than the tilting about the second axis.

The cutting tool holder may be configured to advance toward a workpiece rotating about a workpiece axis, a cutting plane being defined passing through the workpiece axis parallel to the radial direction, the first axis being parallel to the cutting plane.

The cutting tool holder may be configured to perform a turning operation.

According to a still further aspect of the presently disclosed subject matter, there is provided a method of manufacturing a cutting insert, the cutting insert comprising a top surface, a bottom surface, and side surfaces spanning therebetween, the side surfaces comprising one or more feed-facing side surfaces and one or more radial-facing side surfaces, the method comprising the steps of:
providing an intermediate insert; and
passing a convex cutting tool along the top surface parallel and adjacent to at least one of the feed-facing surfaces, thereby forming a linear chip breaker;
   wherein the chip breaker is characterized by a constant profile along the entire length of its respective feed-facing surface.

The cutting insert may further comprise a cavity formed therein, the cavity having an opening formed in the bottom surface and converging upwardly toward a top end thereof (i.e., of the cavity) disposed adjacent to the cutting edge, the side surface and the top end of the cavity defining a thin-walled structure therebetween.

The one or more feed-facing side surfaces may be disposed at an acute feed-angle with respect to the top surface, and each of the radial-facing side surfaces is disposed at an acute radial-angle with respect to the top surface, the feed-angle being greater than the radial-angle.

The convex cutting tool may be a grinder.

According to a still further aspect of the presently disclosed subject matter, there is provided a method of manufacturing a cutting insert, the cutting insert comprising a top surface, a bottom surface, a side surface therebetween, and a cutting edge defined at a portion of the top and side surfaces, the cutting insert further comprising a cavity formed therein, the cavity having an opening formed in the bottom surface and converging upwardly toward a top end thereof (i.e., of the cavity) disposed adjacent to the cutting edge, the side surface and the top end of the cavity defining a thin-walled structure therebetween, the method comprising the steps of:
providing an intermediate insert, the intermediate insert comprising the cutting insert and an overhang projecting from an external surface of the thin-walled structure; and
removing the overhang.

The overhang may be removed with a grinding tool formed with a groove.

According to a still further aspect of the presently disclosed subject matter, there is provided a cutting tool holder comprising a body having an insert seat space, formed at a distal end thereof, for mounting therein a cutting insert, the body comprising a base and at least one sidewall defining therebetween the insert seat space, the cutting tool holder further comprising a nozzle projecting into the insert seat space, the nozzle comprising an orifice at a first end thereof disposed within the insert seat space, and being in fluid communication with a cooling provisioning arrangement, configured to provide a cooling medium, at a second end thereof.

The nozzle may project from the base.

The nozzle may be open to the insert seat space at a point remote from the base.

The orifice may be disposed above the base at a distance which is more than half the height of that of the sidewalls.

The nozzle may be disposed at an angle to the base.

The cutting tool holder may further comprise a fluid outlet open to the insert seat space.

The nozzle being formed as a unitary element of the body, or it may be attachable to the body.

The cooling provisioning arrangement may be configured to provide the cooling medium such that cavitation occurs therein after exiting the nozzle.

According to a still further aspect of the presently disclosed subject matter, there is provided a cutting insert comprising a top surface, a bottom surface, a side surface therebetween, and a cutting edge defined at a portion of the top and side surfaces, the cutting insert further comprising a cavity formed therein, the cavity having an opening formed in the bottom surface and converging upwardly toward a top end thereof (i.e., of the cavity) disposed adjacent to the cutting edge, the side surface and the top end of the cavity defining a thin-walled structure therebetween, the cutting insert further comprising one or more auxiliary discharge apertures spanning between the top end of the cavity and the side surface.

The opening may define an inlet and outlet for a cooling medium, wherein the total cross-sectional area of the auxiliary discharge apertures is less than that of the outlet defined by the opening.

The cutting insert may further comprise one or more discharge outlets formed at least partially in the side surface adjacent the bottom surface.

According to a still further aspect of the presently disclosed subject matter, there is provided a cutting tool comprising a cutting tool holder as described above, and a cutting insert as described above mounted in the insert seat space thereof, wherein the nozzle of the cutting tool holder projects into the cavity of the cutting insert.

According to a still further aspect of the presently disclosed subject matter, there is provided a method of performing a cutting operation, the method comprising:
providing a cutting tool as described above;
performing the cutting operation on a workpiece; and
providing a cooling medium to the cavity of the cutting insert via the nozzle while performing the cutting operation.

The cooling medium may be nitrogen being in a liquid state upon exiting the nozzle.

The cooling medium may be provided at a pressure of up to about 25 atm.

The cooling medium may be provided at a rate of less than about 0.5 liters/minute.

The cooling medium may be provided at such a pressure that cavitation occurs therein after exiting the nozzle.

According to a still further aspect of the presently disclosed subject matter, there is provided a cutting insert comprising a top surface, a bottom surface, a side surface therebetween, and a cutting edge defined at a portion of the top and side surfaces, the cutting insert further comprising a cavity formed therein, an internal surface of the cavity comprising a front interior surface adjacent the side surface and a rear interior surface, the front and rear interior surfaces spanning between an opening formed in the bottom surface and converging upwardly toward a top end of the internal surface being disposed adjacent to the cutting edge, the side surface and the top end of the cavity defining a thin-walled structure therebetween, the cutting insert further comprising one or more ribs projecting into the cavity from its top end;

at least some of the ribs being characterized by side faces forming a cuspated edge at a first part of a distal portion thereof being closer to the rear interior surface, and being spaced from one another and having a bottom-facing surface at a second part of a distal portion thereof being closer to the front interior surface.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a perspective view of an example of a cutting tool according to the presently disclosed subject matter;

FIG. 2A is a perspective view of a cutting insert of the cutting tool illustrated in FIG. 1;

FIG. 2B is a cross-sectional view taken along line II-II in FIG. 2A;

FIG. 2C is a bottom perspective view of a cavity of the cutting insert illustrated in FIG. 2A;

FIG. 2D is a bottom perspective view of a cavity of another example of the cutting insert illustrated in FIG. 2A;

FIG. 2E is a partial perspective view taken along line II-II in FIG. 2D;

FIGS. 3A through 3E are partial cross-sectional views of a top front corner of different examples of the cutting insert illustrated in FIG. 2A;

FIG. 4A is a perspective view of a cutting tool holder of the cutting tool illustrated in FIG. 1;

FIG. 4B is a cross-sectional view taken along line IV-IV in FIG. 4A;

FIG. 5A is a perspective view of a nozzle of the cutting tool holder illustrated in FIG. 4A;

FIG. 5B is a cross-sectional view taken along line V-V in FIG. 5A;

FIG. 6 is a close-up cross-sectional view taken along line VI-VI in FIG. 1;

FIG. 7A illustrates a method for manufacturing a cutting insert;

FIG. 7B is a perspective view of an intermediate insert for use with the method illustrated in FIG. 7A;

FIG. 7C is a cross-sectional view taken along line VII-VII in FIG. 7B;

FIG. 7D is a top view of removal of an overhang of the intermediate insert illustrated in FIG. 7B; and

FIG. 8A illustrates another example of a cutting tool according to the presently disclosed subject matter;

FIG. 8B is a perspective view of a cutting insert of the cutting tool illustrated in FIG. 8A;

FIGS. 8C and 8D are, respectively, radial-facing and feed-facing side views of the cutting insert illustrated in FIG. 8B;

FIGS. 8E and 8F are, respectively, rear perspective and side views of the cutting tool illustrated in FIG. 8A, during a cutting operation;

FIGS. 8G and 8H are, respectively, perspective and feed-facing side views of a cutting tool holder of the cutting tool illustrated in FIG. 8A; and

FIGS. 8I and 8J are, respectively, radial-facing and feed-facing side views of the cutting tool, illustrating clearance angles defined by side surfaces of the cutting insert when mounted in the cutting tool holder.

### DETAILED DESCRIPTION

As illustrated in FIG. 1, there is provided a cutting tool, which is generally indicated at 10. The cutting tool 10 comprises a cutting insert 12 (for example as described and/or illustrated in US 2016/0368061, the full contents of which are incorporated herein by reference) securely mounted within a cutting tool holder 14. The cutting tool 10 may further comprise a base plate 16, for example made of widia, disposed between the cutting insert 12 and the cutting tool holder 14. It will be appreciated that descriptions herein of features of the cutting insert 12 and/or the cutting tool holder 14 may cutting tool 10 comprises a cutting insert 12 securely mounted within a cutting tool holder 14. The cutting tool 10 may further comprise a base plate 16, for example made of widia, disposed between the cutting insert 12 and the cutting tool holder 14. It will be appreciated that features described herein with reference to and/or illustrated in the accompanying drawings, and/or recited in the appended claims, as constituting elements of the cutting insert 12 and/or the cutting tool holder 14 may be provided on the base plate 16, and vice versa.

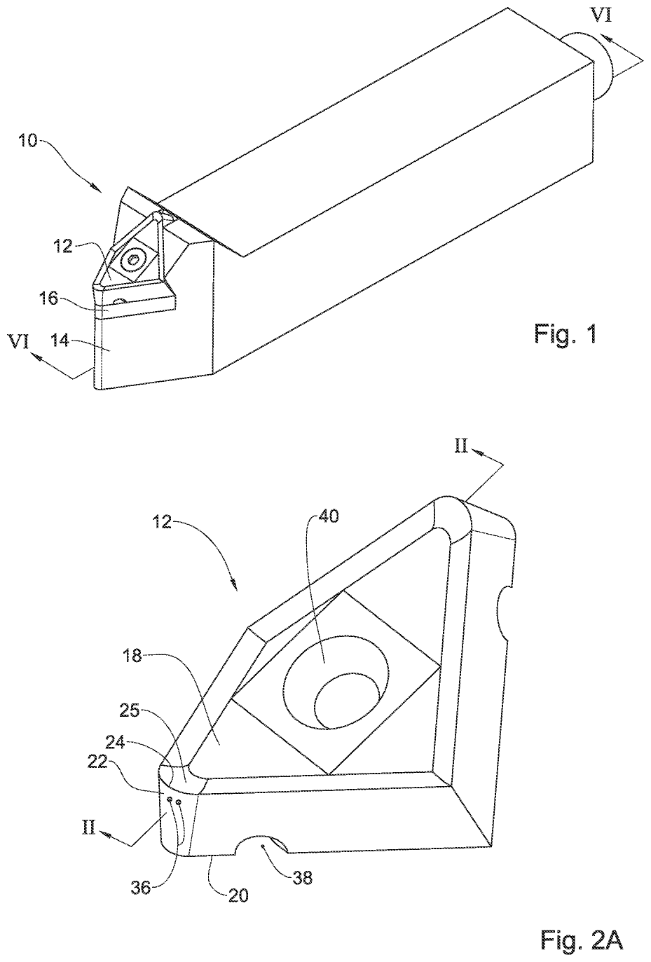

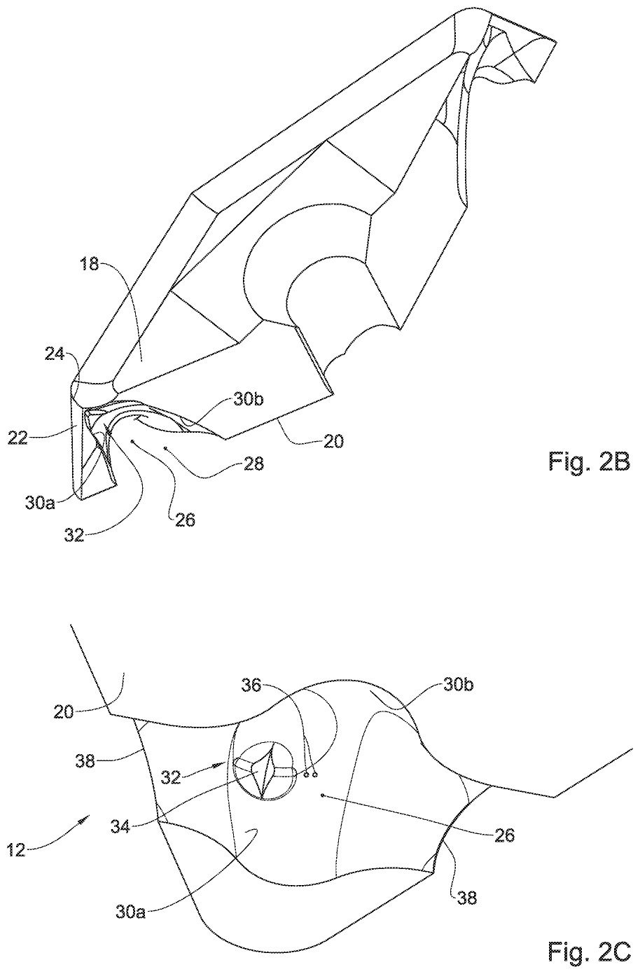

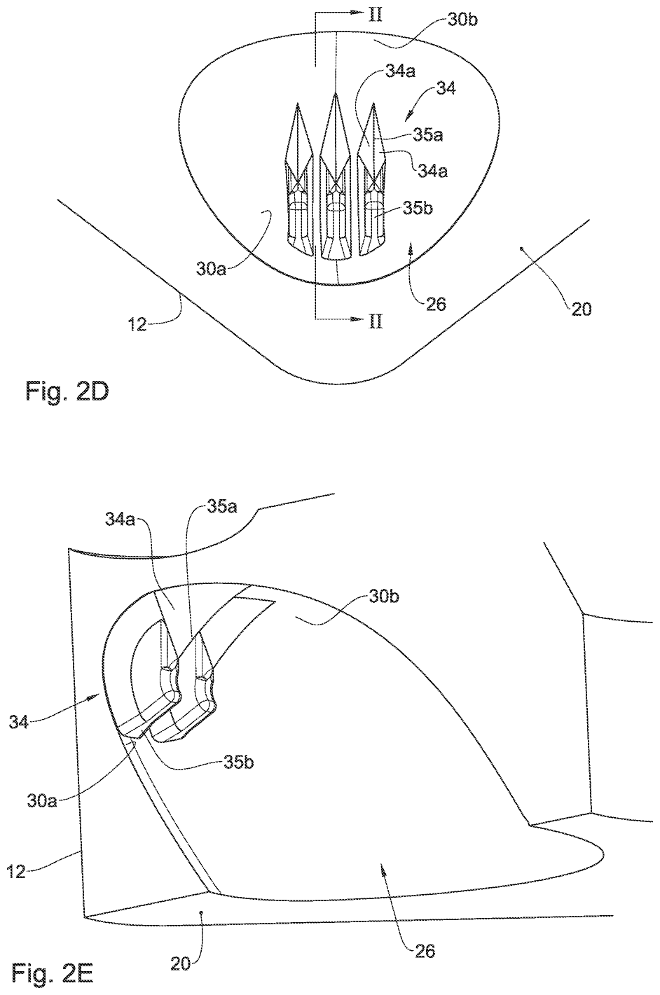

As illustrated in FIGS. 2A and 2B, the cutting insert 12 comprises a top surface 18, a bottom surface 20, and a side surface 22 spanning therebetween. When the cutting insert 12 is mounted in the cutting tool holder 14, a portion of the top surface 18 constitutes a rake surface, and a portion of the side surface 22 constitutes a relief surface, with a cutting edge 24 defined therebetween at the intersection of the rake and relief surfaces (i.e., the top and side surfaces), and the bottom surface 20 typically held flat against the cutting tool holder. The cutting insert 12 may further comprise a chip breaker 25, for example formed as a curved channel formed around at least a portion of the perimeter of the top surface 18.

It will be appreciated that herein the disclosure and claims, terms relating to direction, such as top, bottom, up, down, etc., and similar/related terms are used with reference to the orientation in the accompanying drawings based on a typical usage of the cutting tool 10 and its constituent elements, unless indicated otherwise or clear from context, and is not to be construed as limiting. Similarly, front (and related terms) refers to a direction toward a workpiece, and rear (as related terms) refers to a direction away from the workpiece.

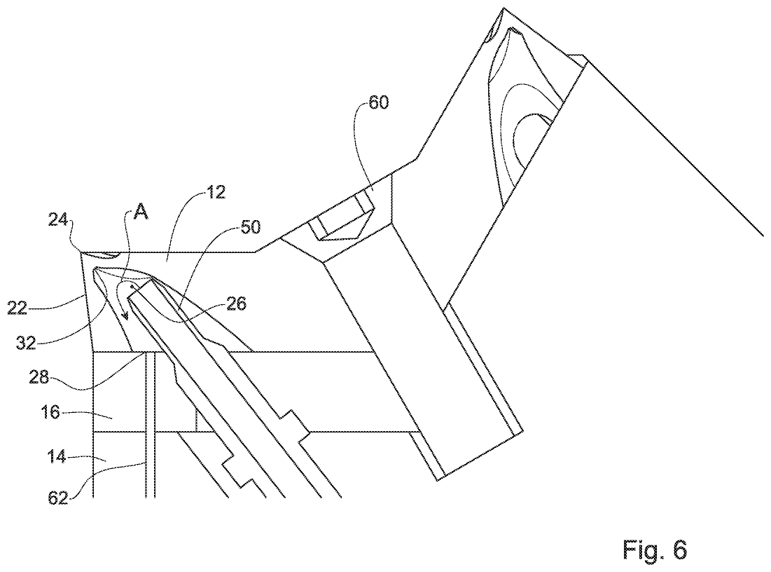

The cutting insert 12 is formed with an internal cavity, which is generally indicated at 26. The cavity 26 comprises an opening 28 formed in the bottom surface 20 of the cutting insert 12, thereby providing access to the cavity from the bottom side thereof. When the cutting insert 12 is mounted in the cutting tool holder 14, e.g., as described above, the opening 28 of the cavity 26 abuts the cutting tool holder 14. Front and rear interior surfaces 30a, 30b of the cavity 26 converge toward a top end 32 thereof, such that the width of the cavity decreases along its height. (In the present disclosure, the entire interior surface is referred to using reference numeral 30.) Such a shape of the cavity 26 facilitates continuous introduction of a cooling medium (typically a fluid, e.g., water, although any other suitable fluid, such as a gas or a liquid, may be used) therein and simultaneous exit thereof during a cutting operation (for example along a flow path indicated by arrow A in FIG. 6). Accordingly, the opening 28 may constitute an entrance and an exit of the cavity 26.

The cavity 26 is formed such that the top end 32 of the cavity 26 is adjacent the cutting edge 24, e.g., wherein the front interior surface 30a of the cavity and a front of the side surface 22 define a thin-walled structure therebetween.

It will be appreciated that herein the specification and appended claims, descriptions/recitations of the cutting edge 24 being adjacent a portion of the cavity, a thin-walled structure between an outer surface of the cutting insert 12 and a portion of the cavity 26, and other similar descriptions/recitations (e.g., as clear from context) clearly convey to one having skill in the art as referring to a construction of the cutting insert in which the amount of material between the cavity and the outer surface of the cutting insert is small enough such that introduction of a cooling medium, such as a liquid, gas, combination thereof, etc., into the cavity during a cutting operation significantly reduces the temperature of the cutting insert, for example in the vicinity of the cutting edge. The significance of the temperature reduction may be, e.g., such that the useful life of the cutting insert is increased thereby at least as much as it would be reduced owing to any loss in structural integrity which may result from providing a thin-walled structure in the vicinity of the cutting edge. For example, the thickness of the thin-walled structure, e.g., between the top end 32 of the cavity 26 and the cutting edge 24 and/or between the front surface 30a of the cavity and a front of the side surface 22, may be no greater than half the height (i.e., the distance between the top and bottom surfaces 18, 20) of the cutting insert 12. According to some examples, it is no greater than one third. According to other examples, it is no greater than one quarter, one fifth, one tenth, or even less, the height of the cutting insert 12.

According to some examples the thickness of the thin-walled structure does not exceed 2 mm at is thinnest point. According to other examples, the thickness of the thin-walled structure does not exceed 1 mm at is thinnest point. According to further examples, the thickness of the thin-walled structure does not exceed 0.5 mm at is thinnest point.

As best seen in FIG. 2C, according to some examples, one or more ribs 34 (references herein to a single element, e.g., a rib, are to be understood as implicitly including examples wherein more than one of such element is provided, unless otherwise evident from context, mutatis mutandis) may be formed on the interior surface(s) 30a, 30b of the cavity 26, for example at or near the top end 32 thereof. Such a rib 34 may facilitate reducing the thickness of thin-walled structure in the vicinity of the cutting edge 24, further reducing the necessary thickness thereof to withstand forces which arise during a cutting operation. In addition, providing ribs 34 increases the surface area of the interior surface(s) 30a, 30b of the cavity 26, thereby facilitating a more efficient cooling by the cooling medium.

According to some examples, as illustrated in FIGS. 2D and 2E, each of the ribs 34 may comprise oppositely disposed side faces 34a. Portions of distal ends, i.e., those projecting furthest into the cavity 26, of the side faces 34a meet to form a cuspated edge 35a extending along a first part of a distal portion of the rib 34 adjacent the rear interior surface 30b of the cavity 26. In addition, according to these examples, a second part of the distal portion of the rib 34 being adjacent the front interior surface 30a of the cavity 26 is formed with a bottom-facing (i.e., generally disposed toward the bottom surface 20 of the cutting insert 12) surface 35b. It will be appreciated that portions of the distal ends of the side faces 34a adjacent the bottom-facing surface 35b are spaced from one another, giving rise to the rib 34 having a thickness therebetween. Accordingly, the rib 34 is strengthened in this area, in particular with regard to its tensile strength, the importance of which will be discussed below.

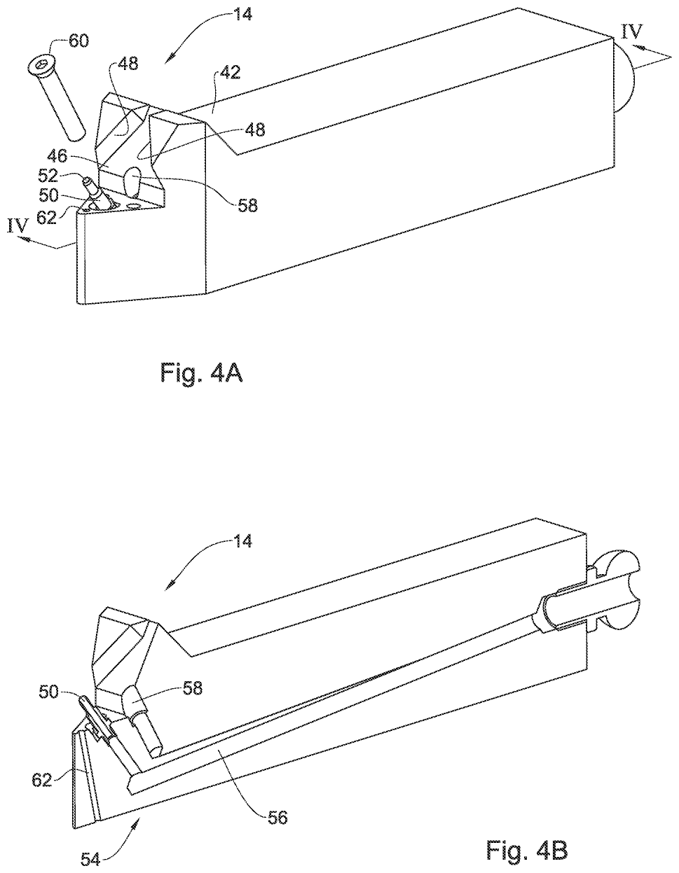

It has been found that when cooling medium is directed at the rib 34 from a direction along the rear interior surface 30b of the cavity 26 (for example using the nozzle 50 described below with reference to an as illustrated in FIGS. 4A through 6), its velocity is extremely high when it first impacts the rib, which occurs at the first part of a distal portion of the rib 34 adjacent the rear interior surface of the cavity. Accordingly, the cooling provided thereby is relatively high. However, as the cooling medium flows along the side faces 34a of the rib 34 toward the front interior surface 30a of the cavity 26, it slows considerably. This, along with the increase in temperature of the cooling medium as it extracts heat from the rib 34, results in the cooling medium providing a significantly lower amount of cooling as it approaches the second part of the distal portion of the rib adjacent the front interior surface 30a of the cavity 26. In addition, it has been found that during a cutting operation, for example wherein the rib 34 is disposed below the chip breaker 25, portions of the rib which are disposed farthest from the interior surface experience the most stress.

Accordingly, a rib 34 as described above with reference to and as illustrated in FIGS. 2D and 2E is characterized in that it is strengthened, specifically in an area thereof which subject to high levels of stress during a cutting operation, for example compared to the level of stress experienced, inter alia, by the first part of the distal portion of the rib (i.e., that being adjacent the rear interior surface of the cavity). As this area of the rib 34 does not significantly contribute to the cooling provided by a cooling medium, as mentioned above, the increased thickness of the rib does not significantly affect the cooling provided by the rib. However, the increased tensile strength in the area which typically experiences the highest level of stress may increase the efficacy of the cutting insert 12.

It will be appreciated that while FIGS. 2D and 2E illustrate an example wherein the cutting insert 12 comprises three ribs 34, a cutting insert may be provided with one or any other suitable number of ribs, without departing from the scope of the presently disclosed subject matter, mutatis mutandis. Moreover, the ribs 34 may be located centrally, e.g., symmetrically within the cavity 26, or may be located off-center, i.e., asymmetrically therewithin. The selection of location of the one or more ribs 34 may be such as to optimize the provision of both cooling and to strengthen of the cutting insert. For example, providing the rib 34 off-center may be useful wherein during use, an off-center portion of the cutting edge 24 contacts the workpiece to perform the operation; accordingly, for example, the increased mechanical strength and/or surface area for heat dissipation may be provided as close as possible to the portion of the cutting edge engaged in the cutting operation.

It will be appreciated that one or more ribs 34 comprising an edge surface 34b such as described above may be provided as part of any suitable cutting insert, for example those described in US 2016/0368061, mutatis mutandis.

The cutting insert 12 may further comprise one or more auxiliary discharge apertures 36, spanning between the cavity 26, e.g., at or near the top end 32 thereof (for example at the same height as at least part of the rib 34, according to examples in which the cutting insert comprises both one or more auxiliary discharge apertures as well as a rib), and an exterior surface of the cutting insert 12. The auxiliary discharge apertures 36 may have any suitable shape, such as rounded, for example to maintain the strength of the thin-walled structure formed between the cavity 26 and the side surface 22.

When cooling medium is provided within the cavity 26, a small portion of it exits through the auxiliary discharge apertures 36, providing further cooling of the cutting insert 12, e.g., in particular in the area thereof near its cutting edge 24. According to some examples, the auxiliary discharge apertures 36 open, on their exterior ends, to the side surface 22 (i.e., relief surface) of the cutting insert 12. Accordingly, they may facilitate supplying cooling medium from inside the cavity 26 directly onto the workpiece, thereby cooling it. Furthermore, some of the cooling medium which exited via the auxiliary discharge apertures 36 may contact the side surface 22, thereby further cooling the cutting insert 12 from its exterior. In addition, as some of the cooling medium introduced into the cavity 26 during a cutting operation exits via the auxiliary discharge apertures 36, the rate of introduction of cooling medium to the cavity 26 may be increased.

It will be appreciated that as the auxiliary discharge apertures 36 have a cross-sectional area which is much smaller than the opening 28 of the cavity 26, they allow a only small portion of the cooling medium within the cavity to flow therethrough (while the remainder exits via the opening); accordingly, most of the cooling medium introduced into the cavity 26 during a cutting operation to lower the temperature of the cutting insert 12 exits via the opening 28 thereof, with only a small proportion thereof exiting via the auxiliary discharge apertures 36.

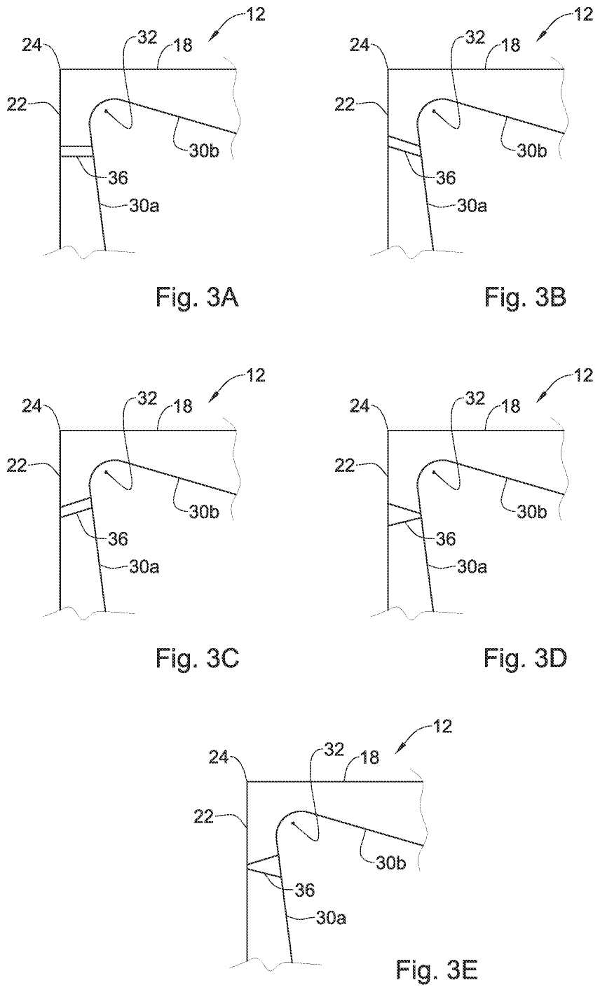

It will be further appreciated that, as illustrated in FIG. 3A, the auxiliary discharge apertures 36 may be substantially horizontal (i.e., parallel to the top and/or bottom surfaces 18, 20) and of constant cross-section, and/or they may be provided angled thereto, such as upwardly or downwardly (such as illustrated, respectively, in FIGS. 3B and 3C). In addition, the auxiliary discharge apertures 36, irrespective of their orientation, may be characterized by a cross-sectional area which increases or decreases along their lengths (such as illustrated, respectively, in FIGS. 3D and 3E).

According to some examples, the cutting insert 12 further comprise one or more discharge outlets 38 in flow communication with (e.g., being open to) a bottom portion of the cavity 26. The discharge outlets 38 facilitate discharge of cooling medium from the cavity 26 during use when cooling medium is supplied thereto. The discharge outlets are at least partially formed in the surface 22 of the cutting insert 12, thereby directing discharged cooling medium to be expelled even when no fluid path is available for such via the bottom surface 20.

The cutting insert 12 may comprise other features as will be recognized by one having skill in the art, including, but not limited to, a mounting aperture 40, without departing from the scope of the presently disclosed subject matter, mutatis mutandis.

As illustrated in FIGS. 4A and 4B, the cutting tool holder 14 comprises a main body 42 with an insert seat space 44, for mounting therein of the cutting insert 12, formed at a distal end thereof. The insert seat space 44 is defined between a base 46 and two sidewalls 48 extending generally upwardly therefrom. The base 46 and sidewalls 48 may be formed correspondingly with the bottom and rear side surfaces 20, 22, respectively, of the cutting insert 12. (In the example illustrated in FIG. 4, the base 46 corresponds to a base of the base plate 16, not illustrated, which has an upper surface corresponding to the bottom surface 20 of the cutting insert 12.)

The cutting tool holder 14 further comprises a cooling nozzle 50, projecting into the insert seat space 44, for example from the base 46. The nozzle 50 may be formed as a unitary element of the main body 42, or be configured for attachment/detachment thereto/from. According to some examples, the nozzle 50 is angled distally with respect to the base 46. The nozzle 50 may be disposed such that fluid supplied thereto is ejected therefrom toward the top end 32 of the cavity 26, along the rear interior surface 30b thereof.

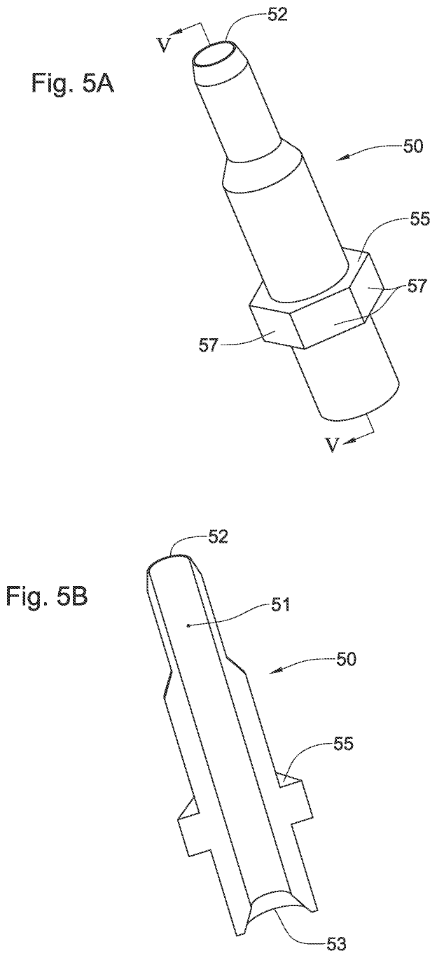

As seen better in FIGS. 5A and 5B, the nozzle 50 comprises a through-going bore 51, spanning between an inlet orifice 53 through which cooling medium enters the nozzle, and an outlet orifice 52 through which cooling medium exits the nozzle and is provided to the cavity 26 of the cutting insert 12, as will be described below. The shape of the bore 51, e.g., the profile along its length, may be as per any suitable design, for example to facilitate providing the cooling medium with one or more desired flow characteristics (e.g., pressure, Reynolds number, Dean number, etc.), for example for one or more considerations mentioned below. In addition, the nozzle 50 may comprise a grip portion 55, comprising a plurality (in particular an even number) of circumferential flat surfaces 57, in order to allow gripping by an external tool, such as a wrench, e.g., in order to facilitate installation/removal thereof from the main body 42 of the cutting tool holder 14 (it will be appreciated that this optional feature would typically not be included, e.g., wherein the nozzle is formed as a unitary element of the main body 42).

According to some examples, the nozzle 50 extends above the base 46 more than half the height of the sidewalls 48, such that, when the cutting insert 12 is mounted within the insert seat space 44, it projects a significant distance within the cavity 26, i.e., such that the outlet orifice 52 is disposed deep therewithin.

According to some examples, the cutting tool holder 14 further comprises a cooling provisioning arrangement, which is generally indicated at 54. The cooling provisioning arrangement 54 may comprise a conduit 56, for example along the length of the main body 42, connected or connectable at a discharge end thereof to the nozzle 50, and at a supply end thereof to a cooling medium source (not illustrated).

The cooling medium source may comprise, for example, a pump, such as is known in the art, which is configured to provide cooling medium to the cooling provisioning arrangement 54 at a particular capacity. According to some examples, the cooling medium source further comprises an additional booster, for example an electric pressure booster, configured to increase the pressure of the cooling medium supplied thereby. According to other examples, the cooling medium source may be operated such that the rate of supply is lowered in order to increase the pressure of the cooling medium (e.g., a pump which is configured to provide 50 liters/minute of cooling medium at a pressure of 20 bar, may be operated to provide 1 liter/minute of cooling medium at a pressure of 100 bar).

The cutting tool holder 14 may comprise a fastening bore 58, for receipt and securing therein of a fastening member such as a screw 60, open to the insert seat space 44. The fastening bore 58 may be provided according to any suitable design, for example as known in the art. The cutting tool holder 14 may further comprise a fluid outlet 62, for example open to the insert seat space 44 distally from the nozzle 50, configured to facilitate discharge of cooling medium from the cavity 26 during use, while cooling medium is supplied via the nozzle 50. The fluid outlet 62 may be connected to a discharge conduit (not illustrated), or open below the cutting tool holder 14, allowing cooling medium to freely drain therefrom. It will be appreciated that the path of cooling medium flow within the cavity 26 may be at least partially influenced by the parameters, including positions, of the nozzle 50 and the fluid outlet 62.

It will be appreciated that the cutting tool 10 may be provided with a cutting insert formed with one or more discharge outlets 38 (for example as described above with reference to and illustrated in FIGS. 2A through 2C), a cutting tool holder comprising a fluid outlet 62, or both, without departing from the scope of the presently disclosed subject matter, mutatis mutandis.

In use, for example as best illustrated in FIG. 6, the cutting insert 12 is inserted into the insert seat space 44, and secured therein, for example by passing the screw 60 through the mounting aperture 40 of the cutting insert, and securing it in the fastening bore 58 of the cutting tool holder 14. The bottom surface 20 of the cutting insert 12 lies in registration on the base 46 of the cutting tool holder, and its rear side surfaces 22 lie in registration against the sidewalls 48 thereof.

In this position, the nozzle 50 extends into the cavity 26 of the cutting insert 12, and, according to some examples, is directed toward and/or disposed close to the top end 32 of the cavity. As the top end 32 of the cavity 26 is adjacent the cutting edge 24 of the cutting insert, decreasing the distance within the cavity 26 that the cooling medium must traverse (and thus be heated) before it reaches the top end 32 results in supplying cooling medium at a lower temperature thereto, thereby increasing the efficiency of cooling.

In addition, providing cooling medium via a nozzle 50 arranged such that its orifice 52 is disposed within the cavity 26 of the cutting insert 12 may provide the ability to better control the flow of cooling medium therewithin. For example, as the distance which the cooling medium must traverse within the cavity 26 between the orifice 52 of the nozzle 50 and the top end 32 is reduced, turbulence may be similarly reduced, which may increase the cooling efficiency.

According to some examples, the cooling medium is a liquid, and provided at such a pressure such that when it exits the orifice 52 into the cavity 26, cavitation occurs, forming small vapor cavities within the liquid. The vapor cavities may contribute to microbubble emission boiling, which increases the cooling efficiency. The formation and parameters of the vapor cavities may be influenced by the design of the nozzle 50, the pressure of the cooling medium as it is supplied thereby, and the parameters of the cooling medium itself.

The cooling medium may be provided as liquid nitrogen. The liquid nitrogen may be provided at any suitable pressure, for example up to about 25 atm. When the nitrogen boils, a relatively large amount of heat is removed (i.e., a large amount of cooling is effected) owing to the heat of vaporization of the nitrogen. Moreover, this occurs at the extremely low temperature of the boiling point of nitrogen, i.e., approximately −196° C. Accordingly, it is advantageous that the nitrogen be introduced into the cavity 26 as a liquid, and as close to the interior surface 30 as is practical, or even in contact therewith. Thus, the nozzle 50 may extend deep into to cavity 26, as boiling of the liquid nitrogen may occur soon after it enters the cavity. As the amount of cooling provided by utilizing liquid nitrogen as a cooling medium is extremely high, the amount thereof which is necessary to provide may be relatively low. For example, less than about 0.5 liters/minute may be necessary to provide adequate cooling. Accordingly, the outlet orifice 52 of the nozzle 50 may be extremely small, for example about 0.2 mm in diameter.

While the cutting insert 12 is described herein with reference to and illustrated in the accompanying drawings as comprising a cavity 26 corresponding to each cutting edge 24, it will be appreciated that a cutting insert may be provided in accordance with the presently disclosed subject matter, mutatis mutandis, comprising one or more corners defining cutting edges having a cavity associated therewith (i.e., being formed so as to provide internal cooling to the cutting edge during use), and one or more cutting edges without such a cavity, i.e., internal cooling is only available to some, but not all, cutting edges. It will be appreciated that the cutting edges without an associated cavity may require mounting on a cutting tool holder without a nozzle 50 as described above, or on the cutting tool holder 14 as described above, wherein its nozzle has been removed (according to examples where this is possible).

It will be further appreciated that cutting inserts according to any design, for example those disclosed in US 2016/0368061 or other publications as comprising cavities which may facilitate internal cooling, may be provided such that some of the cutting edges are associated with a cooling cavity, and some of the cutting edges are not associated with cooling cavities, mutatis mutandis.

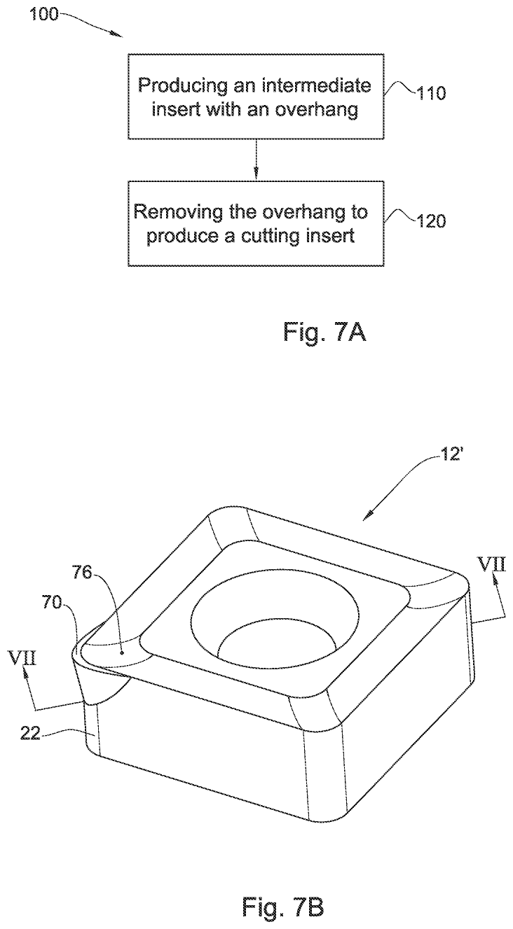

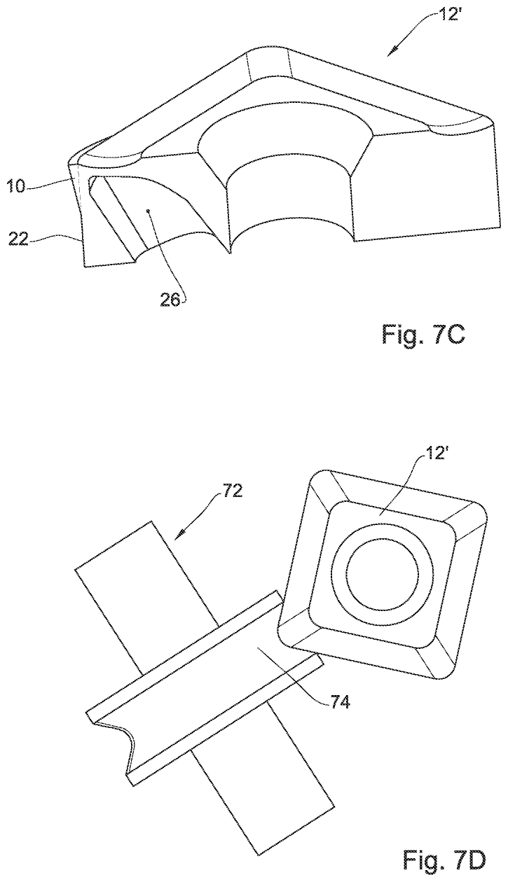

According to some examples, for example as illustrated in FIGS. 7A through 7D, a method 100 may be provided for manufacture of the cutting insert 12, or any other cutting insert comprising a thin-walled structure, for example as described herein with reference to and illustrated in the accompanying drawings. (For simplicity, the method 100 is illustrated using a square cutting insert 12; it will be appreciated that it is applicable for any cutting insert, including that illustrated in FIG. 2A).

In step 110, an intermediate insert 12′ is produced, in any suitable fashion. According to some examples, the intermediate insert 12′ is made in a press mold. In addition to the features of the final cutting insert 12, for example as described above with reference to and illustrated in FIGS. 2A through 3E, the intermediate insert 12′ comprises an overhang 70. The overhang 70 projects outwardly from the exterior surface of the cutting insert 12, for example from a side surface 22 thereof, extending therebeyond as indicated by broken line in FIG. 7C, and formed as a unitary element thereof. In particular, the overhang 70 may be provided adjacent the thinnest portion of the thin-walled structure, i.e., in the vicinity wherein the cavity 26 and the side surface 22 of the cutting insert 12 are closest to one another. Typically, this is close to the cutting edge 24, but may in other areas.

According to examples in which the cutting insert 12 comprises auxiliary discharge apertures 36, and in which the overhang 70 overlaps them, it will be appreciated that they may extend through the overhang (i.e., being formed as through-going apertures in the intermediate insert 12′), or past the side surface 22 of the cutting insert 12 to be formed (indicated by the broken line in FIG. 7C; i.e., being formed as blind apertures in the intermediate insert).

In step 120, the overhang 70 is removed, thereby completing the cutting insert 12. As illustrated in FIG. 7D, the overhang may be ground, for example using a rotating grinding tool 72 formed with a groove 74 (i.e., a concave grinding tool) corresponding to the shape of the side surface 22 of the cutting insert.

The method may be applied as well to forming at least a portion of the chip breaker. For example, the top surface of the intermediate insert 12′ may be formed flat or bulging above the cutting edge, in an area indicated at 76 in FIG. 7B. A cutting tool, such as a convex cutting tool, e.g., a grinder, may remove this portion of the top surface to form the chip breaker of the cutting insert 12. According to some examples, the cutting tool passes in a direction which is parallel to the top surface, and perpendicular (or otherwise traverse) to a plane normal thereto and which bisects the angle formed by the planar side surfaces 22 adjacent the cutting edge. According to some examples, the cutting edge extends linearly in this direction. According to some examples, the cutting edge 24, e.g., formed thusly, may extend higher than the side surfaces 22 immediately adjacent thereto.

It will be appreciated that the method may be used, for example as described above, to form the side surface, top surface (e.g., the chip breaker), and/or any other portion of the cutting insert 12, for example in areas formed with a thin-walled structure.

Using the method described above with reference to and as illustrated in FIGS. 7A through 7D in order to manufacture the cutting insert 12 as described above with reference to and as illustrated in FIGS. 2A through 3E facilitates overcoming difficulties, e.g., which may be associated with press-forming the cutting insert 12, for example arising from structural deficiencies in the thin-walled structure.

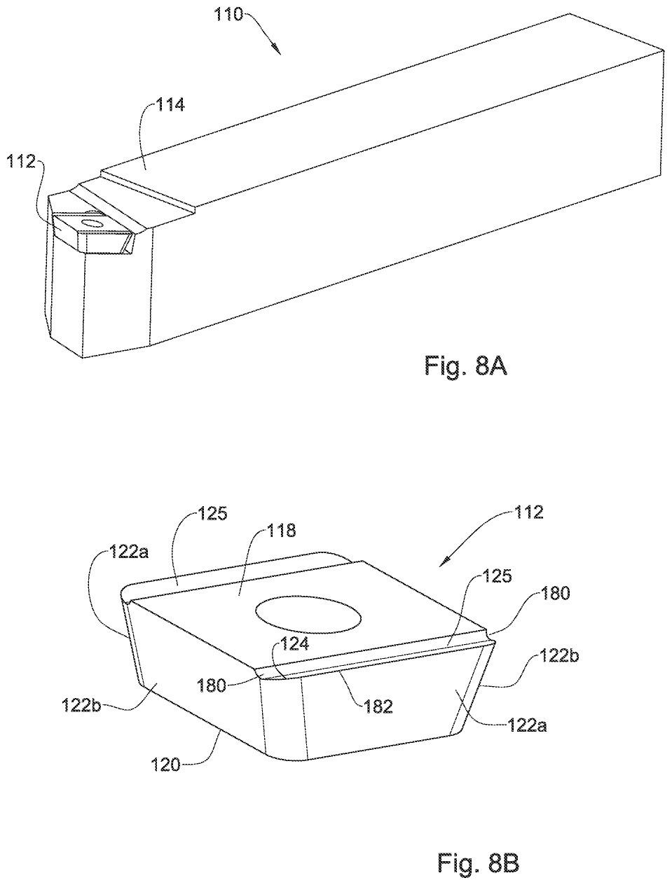

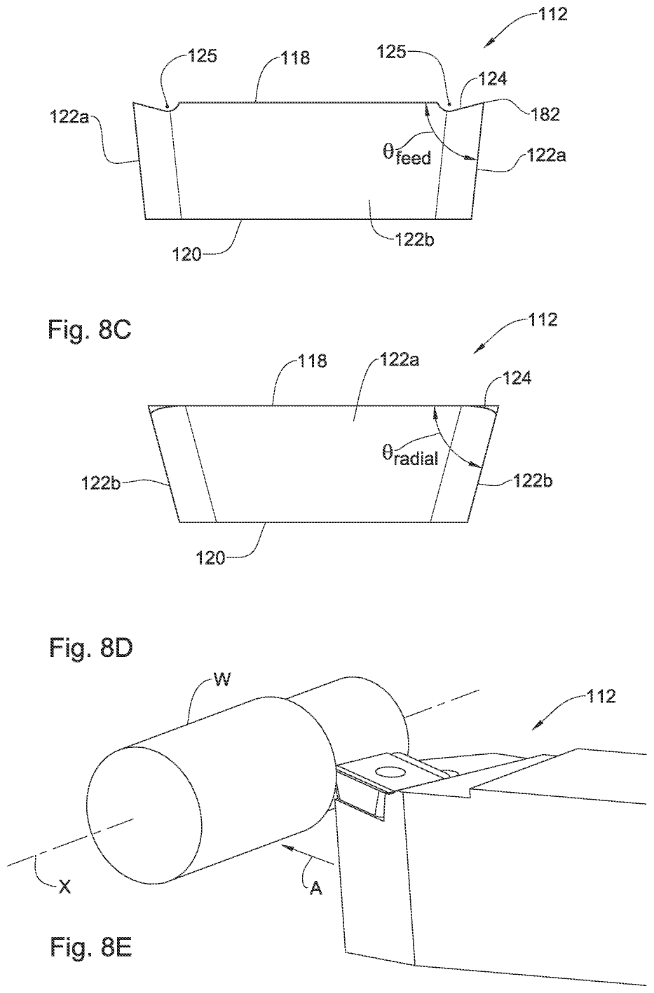

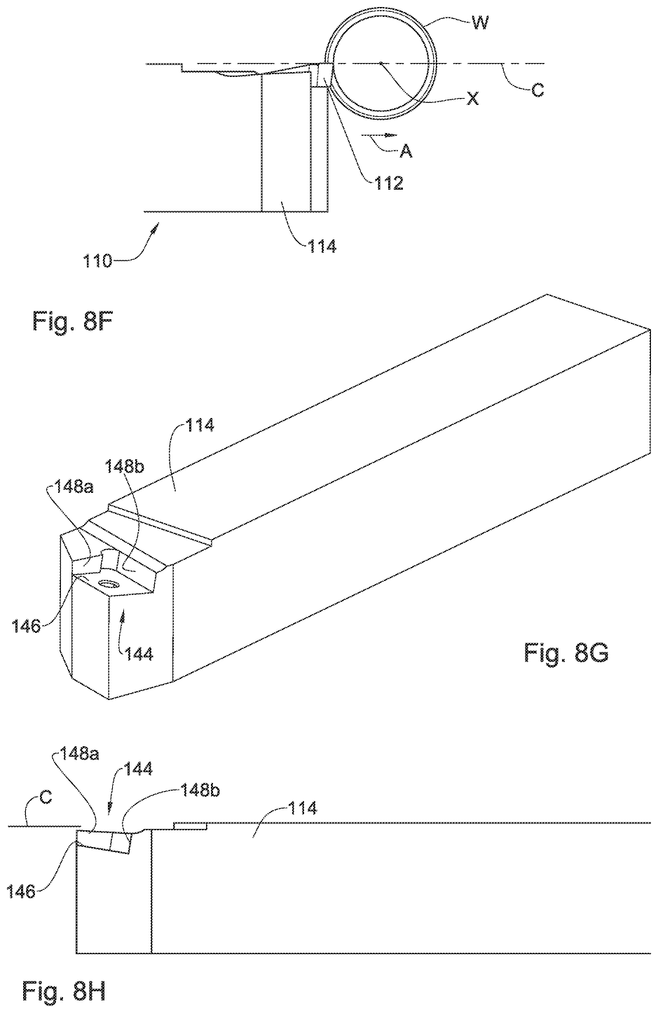

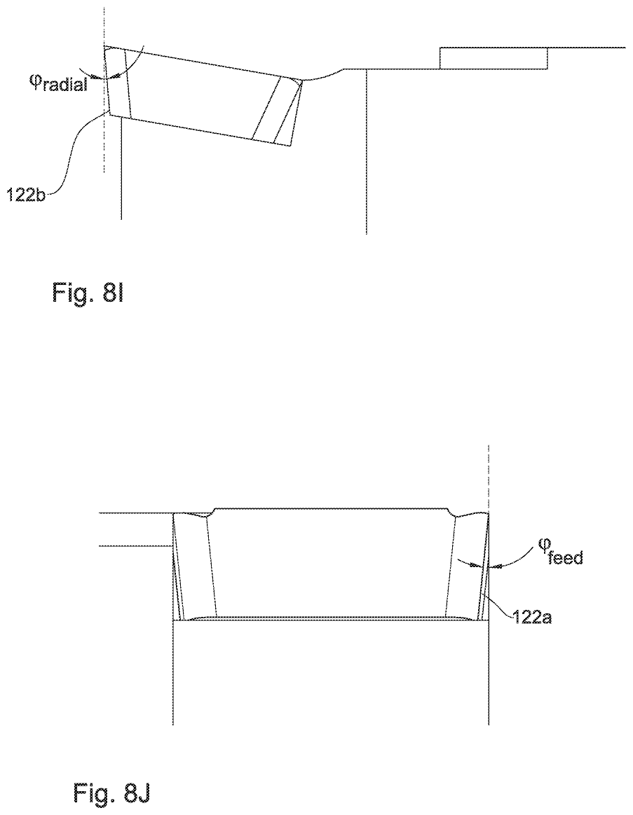

As illustrated in FIG. 8A, a cutting tool, generally indicated at 110, may be provided. The cutting tool 110 comprises a cutting insert 112 securely mounted on a cutting tool holder 114. A baseplate (not illustrated), for example made of widia, may optionally be provided, disposed between the cutting insert 112 and the cutting tool holder 114.

As illustrated in FIG. 8B, the cutting insert 112 comprises a top surface 118, a bottom surface 120, and feed-facing side surfaces 122a and radial-facing side surfaces 122b spanning therebetween. (Herein the specification and appended claims, the feed-facing side surfaces 122a and radial-facing side surfaces 122b may be referred to collectively as side surfaces and/or indicated with reference numeral 122; side surfaces opposite the feed-facing and radial-facing side surfaces 122a, 122b are given the same designations, respectively.) When the cutting insert 112 is mounted in the cutting tool holder 114, a portion of the top surface 118 constitutes a rake surface, and a portion of the side surfaces 122 constitutes a relief surface, with a cutting edge 124 defined therebetween at the intersection of the rake and relief surfaces. The bottom surface 120 typically held flat against the cutting tool holder.

As illustrated in FIGS. 8C and 8D, the feed-facing side surfaces 122a may be disposed such that they each form an acute angle θ_{feed} with the top surface 118, and the radial-facing side surfaces 122b may be disposed such that they each form an acute angle θ_{radial} with the top surface 118, for example being smaller than (Weed, i.e., the radial-facing side surfaces 122b may be angled inwardly toward the bottom surface 120 to a greater degree than are the feed-facing side surfaces.

The top surface 118 comprises one or more chip breakers 125, each comprising a linear groove formed parallel to a feed-facing side surface 122a and disposed adjacent thereto. Ends 180 of each chip breaker 125 are open to the side surfaces 122, for example at the cutting edge 124, i.e., the profile of the chip breaker 125 is constant along the entire length of its respective feed-facing side surface 122a. (It will be appreciated that herein the specification and appended claim, when the chip breaker 125 is described or recited as having a constant profile, this includes that portions of the chip breaker characterized by only a part of the profile, owing, e.g., to the curved shape of the corners of the top surface 118, are formed such their profiles are the same as corresponding parts of portions of the chip breaker characterized by the complete profile.) An upper outer edge 182 of the chip breaker 125 forms an angle θ_{breaker} with the feed-facing side surface 122a.

As seen in FIGS. 8E and 8F, the workpiece, indicated at W, is rotated about a workpiece axis X, and the cutting tool 110 may be advanced, inter alia, in a radial direction transverse to the workpiece axis X, as indicated by arrow A. A cutting plane C is defined passing through the workpiece axis X and parallel to the radial direction A. It will be appreciated that the term cutting plane and its identification are not meant to be restrictive, but are employed to explicate the presently disclosed subject matter; in practice, the cutting tool 110 may contact the workpiece W at a point which is not located on the cutting plane C. Similarly, the cutting tool 110 may be advanced radially along a slightly different direction than that indicated by arrow A.

As illustrated in FIGS. 8G and 8H, the cutting tool holder 114 is formed with an insert seat space 144 for receipt therein of the cutting insert 112 and optional baseplate during use, such that the chip breakers 125 are aligned in a general radial direction, as illustrated. The insert seat space 144 is defined above a base 146 and between a feed-facing sidewall 148a and a radial-facing sidewall 148b extending upwardly therefrom. (Herein the specification and appended claims, the feed-facing and radial-facing sidewalls 148a, 148b may be referred to collectively as sidewalls and/or indicated with reference numeral 148.) The base 146 may be substantially planar, and is angled with respect to the cutting plane C, as best seen in FIG. 8H.

The cutting insert 112 may be mounted in the insert seat space 144 such that its feed-facing side surfaces 122a are disposed parallel to the feed-facing sidewall 148a, and its radial-facing side surfaces 122b are disposed parallel to the radial-facing sidewall 148b.

According to some examples, the base 146 may be angled such that when the insert 112 is received within the insert seat space 144 as described above and illustrated in the accompanying figures, a longitudinal axis of the chip breaker 125 (i.e., being parallel to the upper outer edge 182 thereof) is angled upwardly toward the workpiece, i.e., the base is angled with respect to the cutting plane C about an axis which is perpendicular to the radial-facing side surfaces 122b.

According to some specific examples, the base 146 is only angled with respect to the cutting plane C about an axis perpendicular to the radial-facing side surfaces 122b, i.e., it is not angled with respect to the cutting plane C about an axis which is perpendicular to the feed-facing side surfaces 122a. Accordingly, as illustrated in FIG. 8I, the radial-facing side surface 122b of the cutting insert 112 is disposed such that it forms a radial clearance angle φ_{radial} of between about 5° and about 7° with the workpiece W (i.e., with a vertical plane). As the base is not angled with respect to the cutting plane C about an axis which is perpendicular to the feed-facing side surfaces 122a, a feed clearance angle φ_{feed} between the feed-facing side surface 122a and the workpiece W is defined solely by the acute angle θ_{feed} between the feed-facing side surface and the top surface 118, as illustrated in FIG. 8J.

As mentioned, the radial-facing side surfaces 122b may be angled inwardly toward the bottom surface 120 to a greater degree than are the feed-facing side surfaces, i.e., the acute angle (Weed formed between each of the feed-facing side surfaces 122a and the top surface 118 may be larger than the acute angle θ_{radial} formed between each of the radial-facing side surfaces 122b and the top surface 118. According to examples wherein the base 146 is angled only with respect to the cutting plane C about an axis perpendicular to the radial-facing side surfaces 122b, the difference between the angles θ_{feed}, θ_{radial} may be at least partially bridged by the angular disposition of the cutting insert 112 when mounted on the cutting tool holder 114 according to these examples, i.e., the radial and feed clearance angles φ_{radial}, φ_{feed} may be closer to one another, including being equal, than are the angles θ_{feed}, θ_{radial}.

It will be appreciated that while the cutting insert 112 and associated cutting tool holder 114 described above with reference to and illustrated in FIGS. 8A through 8J may be particularly useful when the method described above with reference to and illustrated in FIGS. 7A through 7D is used for manufacture, any suitable method may be used to manufacture them without departing from the scope of the presently disclosed subject matter, mutatis mutandis.

Those skilled in the art to which this invention pertains will readily appreciate that numerous changes, variations, and modifications can be made without departing from the scope of the presently disclosed subject matter, mutatis mutandis.

1. A cutting tool holder, comprising:
a body having an insert seat space, formed at a distal end thereof, for mounting therein a cutting insert, said body comprising a base and at least one sidewall defining therebetween said insert seat space; and
a nozzle projecting into said insert seat space, said nozzle comprising an orifice at a first end thereof disposed within the insert seat space, and being in fluid communication with a cooling provisioning arrangement, configured to provide a cooling medium, at a second end thereof.

2. The cutting tool holder according to claim 1, wherein said nozzle projects from said base.

3. The cutting tool holder according to claim 1, wherein said nozzle is open to the insert seat space at a point remote from said base.

4. The cutting tool holder according to claim 1, wherein said orifice is disposed above the base at a distance which is more than half the height of that of the sidewalls.

5. The cutting tool holder according to claim 1, wherein said nozzle is disposed at an angle to said base.

6. The cutting tool holder according to claim 1, further comprising a fluid outlet open to said insert seat space.

7. The cutting tool holder according to claim 1, said nozzle being formed as a unitary element of said body.

8. The cutting tool holder according to claim 1, said nozzle being attachable to said body.

9. The cutting tool holder according to claim 1, wherein said cooling provisioning arrangement is configured to provide said cooling medium such that cavitation occurs therein after exiting said nozzle.

10. A cutting insert, comprising:
a top surface;
a bottom surface;
a side surface between the top surface and the bottom surface;
a cutting edge defined at a portion of said top and side surfaces; and
a cavity formed therein, said cavity having an opening formed in said bottom surface and converging upwardly toward a top end thereof disposed adjacent to said cutting edge, said side surface and said top end of the cavity defining a thin-walled structure therebetween, the cutting insert further comprising one or more auxiliary discharge apertures spanning between said top end of the cavity and said side surface.

11. The cutting insert according to claim 10, said opening defining an inlet and outlet for a cooling medium, wherein the total cross-sectional area of said auxiliary discharge apertures is less than that of the outlet defined by said opening.

12. The cutting insert according to claim 10, further comprising one or more discharge outlets formed at least partially in said side surface adjacent the bottom surface.

13. A cutting tool comprising the cutting tool holder according to claim 1, and the cutting insert according claim 10 mounted in the insert seat space thereof, wherein the nozzle of said cutting tool holder projects into the cavity of said cutting insert.

14. A method of performing a cutting operation, the method comprising:
providing the cutting tool according to claim 13;
performing said cutting operation on a workpiece; and
providing a cooling medium to the cavity of the cutting insert via the nozzle while performing the cutting operation.

15. The method according to claim 14, wherein said cooling medium is nitrogen being in a liquid state upon exiting the nozzle.

16. The method according to claim 15, wherein the cooling medium is provided at a pressure of up to about 25 atm.

17. The method according to claim 14, wherein the cooling medium is provided at a rate of less than about 0.5 liters/minute.

18. The method according to claim 14, wherein the cooling medium is provided at such a pressure that cavitation occurs therein after exiting said nozzle.

19. A cutting insert, comprising:
a top surface;
a bottom surface;
a side surface between the top surface and the bottom surface; and
a cutting edge defined at a portion of said top and side surfaces;
a cavity formed therein, an internal surface of the cavity comprising a front interior surface adjacent said side surface and a rear interior surface, said front and rear interior surfaces spanning between an opening formed in said bottom surface and converging upwardly toward a top end of the internal surface being disposed adjacent to said cutting edge, said side surface and said top end of the cavity defining a thin-walled structure therebetween; and
one or more ribs projecting into the cavity from its top end;
at least some of said ribs being characterized by side faces forming a cuspated edge at a first part of a distal portion thereof being closer to said rear interior surface, and being spaced from one another and having a bottom-facing surface at a second part of a distal portion thereof being closer to said front interior surface.
